(19) United States
(12) Patent Application Publication
(10) Pub. No.: US 2006/0256467 A1
(43) Pub. Date: Nov. 16, 2006

(54) Spindle motor for hard disk drive

(75) Inventors: Chul-woo Lee, Seongnam-si (KR); Woo-cheol Jeong, Anyang-si (KR); Hong-kwon Lee, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/328,083

(22) Filed: Jan. 10, 2006

(30) Foreign Application Priority Data
May 12, 2005 (KR) 10-2005-0039720

(51) Int. Cl. G11B 17/22

(52) U.S. Cl. 360/98.01

(57) ABSTRACT

Provided is a spindle motor for a hard disk drive (HDD). The spindle motor includes a shaft, a stator and a rotator coupled to an outer circumference of the shaft, and a height adjustment member detachably installed on the rotator and adjusting the height of the rotator when the number of data storage disks mounted on the spindle motor is changed. The spindle motor further includes a plurality of spacers mounted around outer circumferences of the height adjustment member and the rotator in order to maintain a distance between adjacent disks, a clamp disposed over the height adjustment member and fixing the disks and the spacers, and a clamping screw coupled to an upper end portion of the spindle motor and fixing the height adjustment member and the clamp. Accordingly, since the height of the rotator can be adjusted using the height adjustment member, the number of disks mounted on the rotator can be changed.

### CROSS-REFERENCE TO RELATED APPLICATIONS

This application claims the benefit of Korean Patent Application No. 10-2005-0039720, filed on May 12, 2005, in the Korean Intellectual Property Office, the disclosure of which is incorporated herein in its entirety by reference.

### BACKGROUND OF THE INVENTION

1. Field of the Invention

The present invention relates to a spindle motor for a hard disk drive (HDD), and more particularly, to a spindle motor that can adjust the height of a hub according to the number of disks mounted on the spindle motor.

2. Description of the Related Art

Hard disk drives (HDDs), which store information on computers, read data stored in a disk or write data to the disk using a read/write head. In the HDDs, the disk is mounted on a spindle motor, and the read/write head functions by being moved to a desired position while flying at a predetermined height from a recording surface of the rotating disk.

FIG. 1 is a cross-sectional view of a conventional spindle motor of an HDD.

Referring to FIG. 1, a spindle motor 30 for rotating disks 21 and 22 is installed on a base member 11 of the HDD.

The spindle motor 30 includes a shaft 31, and a stator 33 and a rotator 34 coupled to an outer circumference of the shaft 31. The rotator 34 is called a hub, and the data storage disks 21 and 22 are mounted around an outer circumference of the hub 34. When the disks 21 and 22 are mounted on the spindle motor 30, a ring-shaped spacer 50 is mounted around the outer circumference of the hub 34 and interposed between disks 21 and 22 to maintain a distance between the disks 21 and 22. A disk-shaped clamp 60 is coupled to an upper end portion of the spindle motor 30 by a clamping screw 70 to firmly fix the disks 21 and 22 to the spindle motor 30.

A cover member 12 of the HDD is disposed over the spindle motor 30.

A data recording density of the disks in HDDs has increased remarkably for the past 50 years. Accordingly, the height of a 2.5″ HDD generally used for notebook computers has decreased from 19 mm to 17 mm, 17 mm to 12.5 mm, and 12.5 mm to 9.5 mm. Recently, HDDs having a height of 9.5 mm in which two disks are installed, as shown in FIG. 1, are now widely used. The height of HDDs has decreased due to the development of light and compact notebook computers. Also, the decrease is a result of the fact that the data recording density of the disks has increased remarkably, and thus the number of disks installed in the HDDs has decreased.

However, since 2000, while the increase in the data-recording density of the disks has slowed down, consumer demands for HDDs with high data storage capacity have increased steadily due to a rapid expansion of the Internet and an increase in the capacity of image information. Accordingly, to increase the data storage capacity, there is no other way but to increase the number of disks installed in HDDs.

For example, in the 2.5″ HDD shown in FIG. 1, to increase data storage capacity, one or more disks should be added to the two disks 21 and 22 mounted on the spindle motor 30. If three disks are installed in the HDD, a height H changes to 12.5 mm, and the spindle motor 30 needs to be replaced with one suitable for the three disks. To this end, the weight of the spindle motor 30 and the thickness of the base member 11 would increase substantially, and power consumption necessary for driving the spindle motor 30 would increase as well.

### SUMMARY OF THE INVENTION

The present invention provides a spindle motor of a hard disk drive, which can change the number of disks mounted on the spindle motor using a height adjustment member for adjusting the height of a hub.

One aspect of the present invention is to provide a spindle motor including a shaft, a stator and a rotator coupled to an outer circumference of the shaft, and a height adjustment member detachably installed on the rotator and adjusting the height of the rotator when the number of data storage disks mounted on the spindle motor is changed.

The spindle motor may further include a plurality of spacers mounted around outer circumferences of the height adjustment member and the rotator to maintain a distance between adjacent disks, a clamp disposed over the height adjustment member and fixing the disks and the spacers, and a clamping screw mounted into an upper end portion of the spindle motor and fixing the height adjustment member and the clamp.

The height adjustment member may have a substantially disk shape, and a screw insertion hole into which the clamping screw is inserted may be formed in the center of the height adjustment member.

The height adjustment member may include an inner circumferential portion, an outer circumferential portion, and an intermediate portion between the inner circumferential portion and the outer circumferential portion. The screw insertion hole may be formed in the center of the inner circumferential portion, and at least one disk and one or more spacers may be mounted around an outer circumferential surface of the outer circumferential portion. The inner circumferential portion and the outer circumferential portion of the height adjustment member may contact a top surface of the rotator, and the intermediate portion of the height adjustment member may have a thickness less than thicknesses of the inner circumferential portion and the outer circumferential portion and may be spaced a predetermined distance from the top surface of the rotator.

The height adjustment member may have a protrusion protruding around the screw insertion hole, and the protrusion may contact the head of the clamping screw to be pressed vertically.

The height of the outer circumference may be equal to the sum of thicknesses of at least one disk and thicknesses of at least one spacer. The diameter of an outer circumferential surface of the height adjustment member may be equal to the diameter of an outer circumferential surface of the rotator.

Two disks may be mounted around the outer circumference of the rotator, and one disk may be mounted around the outer circumference of the height adjustment member.

The height adjustment member may be made of engineering plastic or metal. The metal may be titanium or aluminum.

As described above, since the height of the rotator, i.e., the hub, can be adjusted using the height adjustment member, the number of disks mounted on the rotator can be changed. Accordingly, the spindle motor can be used for a hard disk drive having disks of different numbers.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional spindle motor for a hard disk drive (HDD);

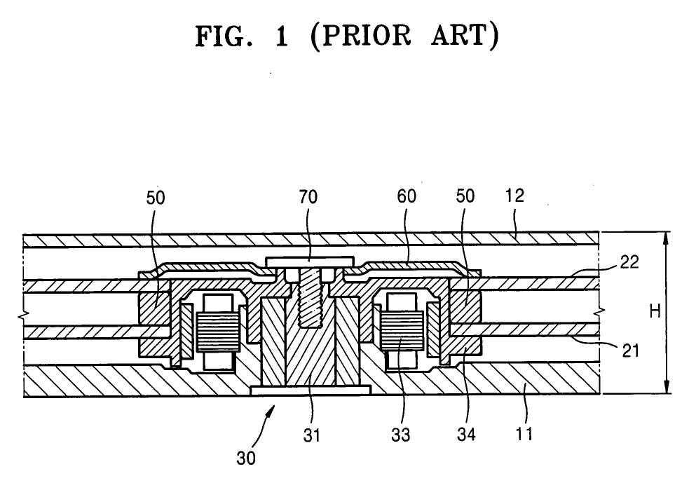

FIG. 2 is an exploded perspective view of an HDD provided with a spindle motor according to an embodiment of the present invention; and

FIG. 3 is a cross-sectional view of the spindle motor of FIG. 2.

### DETAILED DESCRIPTION OF THE INVENTION

The present invention will now be described more fully with reference to the accompanying drawings, in which preferred embodiments of the invention are shown. While the present invention can be applied to hard disk drives (HDDs) of diverse sizes, the present invention will be explained based on a 2.5″ HDD generally used for notebook computers, for convenience in explanation. The same elements are given the same reference numerals throughout the drawings.

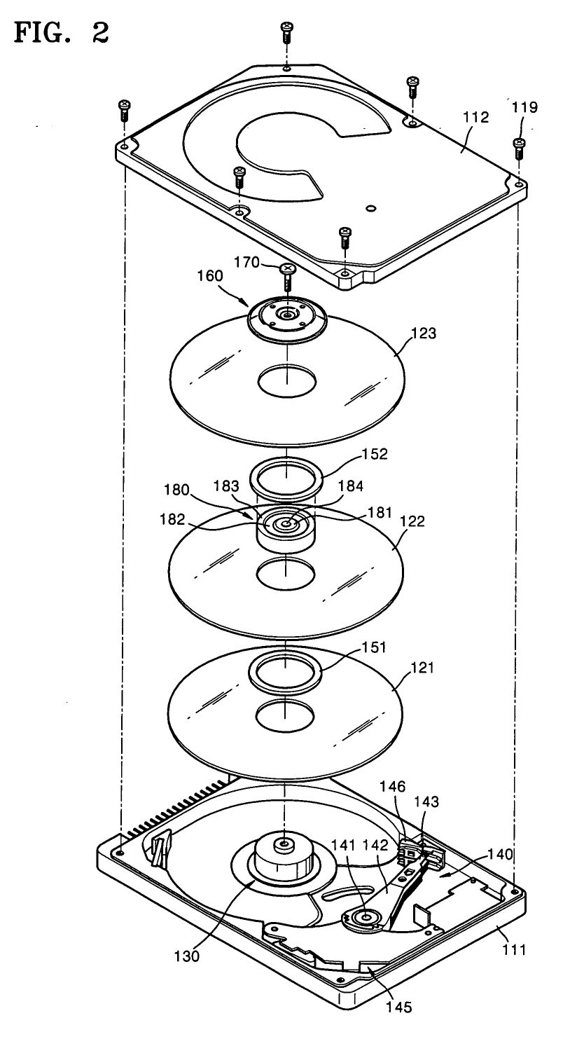

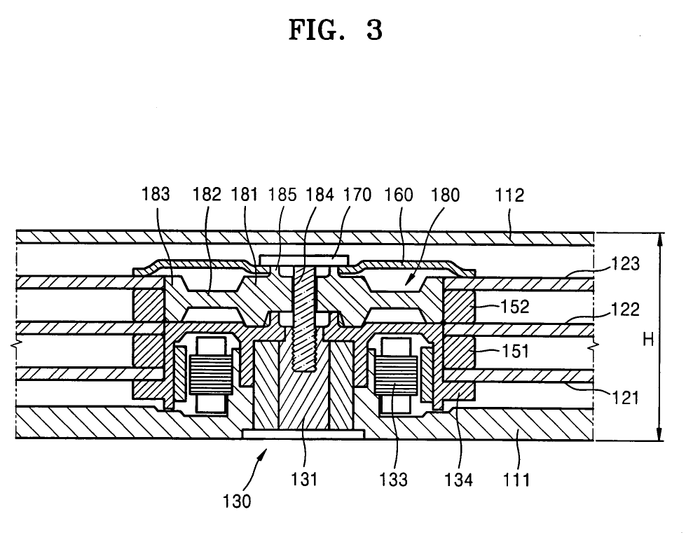

FIG. 2 is an exploded perspective view of an HDD provided with a spindle motor according to an embodiment of the present invention. FIG. 3 is a cross-sectional view of the spindle motor of FIG. 2.

Referring to FIGS. 2 and 3, an HDD includes a base member 111 and a cover member 112, one or more data storage disks 121, 122, and 123, a spindle motor 130 for rotating the disks 121, 122, and 123, and an actuator 140 on which a read/write head is mounted.

The spindle motor 130 and the actuator 140 are accommodated in a space formed in a top surface of the base member 111.

The cover member 112 is adhered to the base member 111 using a plurality of coupling screws 119, and collectively surrounds and protects the disks 121, 122, and 123, the spindle motor 130, and the actuator 140, prevent dust or humidity from entering the inside of the disk drive, and block noises generated in the disk drive from propagating outwardly.

The spindle motor 130 for rotating the disks 121, 122, and 123 mounted thereon will be explained later in detail.

The actuator 140 moves the read/write head for data recording and reproduction to a predetermined position over each of the disks 121, 122, and 123. The actuator 140 includes a swing arm 142, a suspension 143, and a voice coil motor (VCM) 145. The swing arm 142 is rotatably coupled to a pivot 141 that is installed on the base member 111. The suspension 143 is coupled to a front end portion of the swing arm 142 to elastically bias a slider with the read/write head thereon toward a surface of the respective disks 121, 122, and 123. The VCM 145 provides a driving force for rotating the swing arm 142. The VCM 145 is controlled by a servo control system, and rotates the swing arm 142 in a direction according to Fleming's Left Hand Rule due to an interaction between current input to a VCM coil and a magnetic field formed by magnets. That is, when the HDD is turned on and the disks 121, 122, and 123 begin to rotate, the VCM 145 rotates the swing arm 142 counterclockwise to move the read/write head to recording surfaces of the respective disks 121, 122, and 123. In contrast, when the HDD is turned off and the disks 121, 122, and 123 stop rotating, the VCM 145 rotates the swing arm 142 clockwise to remove the read/write head from the disks 121, 122, and 123. Here, the read/write head removed from the recording surfaces of the disks 121, 122, and 123 is parked on a ramp 146 disposed outside the disks 121, 122, and 123.

The spindle motor 130 is installed on the base member 111 and has a structure capable of changing the number of disks 121, 122, and 123 mounted thereon.

In detail, the spindle motor 130 includes a shaft 131, a stator 133 and a rotator 134 coupled to an outer circumference of the shaft 131, and a height adjustment member 180 installed on the rotator 134.

The rotator 134 is generally called a hub, and one or more data storage disks 121 and 122 are mounted around an outer circumference of the hub 134. When the plurality of disks 121 and 122 are mounted around the hub 134 as shown in FIGS. 2 and 3, a ring-shaped spacer 151 is mounted around the outer circumference of the hub 134 and interposed between the disks 121 and 122 to maintain a distance between the disks 121 and 122.

The height adjustment member 180 for adjusting the height of the hub 134 is detachably installed on the hub 134. The height adjustment member 180 has a substantially disk shape, and a screw insertion hole 184 into which a clamping screw 170 is inserted is formed in the center of the height adjustment member 180. The height adjustment member 180 includes an inner circumferential portion 181, an outer circumferential portion 183, and an intermediate portion 182 between the inner and outer circumferential portions 181 and 183. The screw insertion hole 184 is formed in the center of the inner circumferential portion 181, and at least one disk 123 and at least one spacer 152 are mounted around an outer circumferential surface of the outer circumferential portion 183 of the height adjustment member 180. A protrusion 185, shown in FIG. 3, may protrude to a predetermined height around the screw insertion hole 184. The protrusion 185 contacts the head of the clamping screw 170.

Each of the inner circumferential portion 181 and the outer circumferential portion 183 has a relatively great thickness and contacts a top surface of the hub 134. The intermediate portion 182 has a thickness less than the thicknesses of the inner circumferential portion 181 and the outer circumferential portion 183, and is separated a predetermined distance from the top surface of the hub 134. The height adjustment member 180 has this shape in order to minimize weight and suppress transmission of shocks or vibrations. Additionally, the weight of the height adjustment member 180 may be minimized by making the height adjustment member 180 out of engineering plastic or light metal, e.g., titanium or aluminium.

Thus, an increase in the weight of the spindle motor 130 is minimized, and an increase in power consumption necessary for driving the spindle motor 130 is also minimized.

The diameter of an outer circumferential surface of the height adjustment member 180 is equal to the diameter of an outer circumferential surface of the hub 134. The height of the outer circumferential portion 183 of the height adjustment member 180 may vary according to the number of the disks 123 and the spacers 152 mounted around the outer circumference of the height adjustment member 180. For example, when two disks 121 and 122 and one spacer 151 are mounted around the outer circumference of the hub 134, and one disk 133 and one spacer 152 are additionally mounted around the outer circumference of the height adjustment member 180 as shown in FIGS. 2 and 3, the height of the outer circumferential portion 183 is equal to the sum of the thickness of the disk 123 and the thickness of the spacer 152. For example, if the thickness of the disk 123 is approximately 0.635 mm and the thickness of the spacer 152 is approximately 1.85 mm, the height of the outer circumferential portion 183 of the height adjustment member 180 would be approximately 2.485 mm. The total height H of the HDD then becomes approximately 12.5 mm.

Meanwhile, when two disks and two spacers are mounted around the outer circumference of the height adjustment member 180, the height of the outer circumferential portion 183 is equal to the sum of the thicknesses of the two disks and the thicknesses of the two spacers.

As described above, the number of the disks 121, 122, and 123 mounted on the spindle motor 130 can be changed using the height adjustment member 180. That is, when only two disks 121 and 122 are mounted on the spindle motor 130, the height adjustment member 180 does not need to be used. When three disks 121, 122, and 123 are mounted on the spindle motor 130, the height adjustment member 180 is coupled to the spindle motor 130. Thus, even though the number of disks mounted on the spindle motor 130 increases from two to three, the spindle motor 130 does not need to be replaced, and accordingly the base member 111 of the HDD does not need to be changed.

A disk-shaped clamp 160 is installed over the height adjustment member 180 to firmly fix the disks 121, 122, and 123 to the spindle motor 130. The clamp 160 is fixed by the clamping screw 170 that is mounted into an upper end portion of the spindle motor 130, that is, into an upper end portion of the shaft 131. Here, the protrusion 185 of the height adjustment member 180 contacts the head of the clamping screw 170 to be pressed vertically. Accordingly, the height adjustment member 180 is firmly fixed to the hub 134 such that the height adjustment member 180 can rotate together with the hub 134.

As described above, since the height of the rotator, that is, the hub, can be adjusted using the height adjustment member, the number of disks mounted on the rotator can be changed. As a result, even though the number of disks mounted on the HDD is changed, the same spindle motor and base member can be used.

Consequently, the costs for developing and manufacturing the spindle motor and the base member are reduced. Although the number of disks increases, an increase in the weight of the spindle motor is minimized and the thickness of the base member does not change, thereby preventing an increase in power consumption and a decrease in shock absorbing capability.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A spindle motor comprising:
a shaft;
a stator and a rotator coupled to an outer circumference of the shaft; and
a height adjustment member detachably installed on the rotator and adjusting the height of the rotator when the number of data storage disks mounted on the spindle motor is changed.

2. The spindle motor of claim 1, further comprising:
a plurality of spacers mounted around an outer circumferential surface of an outer circumferential portion of the height adjustment member and the rotator and maintaining a distance between adjacent disks;
a clamp disposed over the height adjustment member and fixing the disks and the spacers; and
a clamping screw mounted into an upper end portion of the spindle motor and fixing the height adjustment member and the clamp.

3. The spindle motor of claim 1, wherein the height adjustment member has a substantially disk shape, and a screw insertion hole into which the clamping screw is inserted is formed in the center of the height adjustment member.

4. The spindle motor of claim 3, wherein the height adjustment member includes an inner circumferential portion, the outer circumferential portion, and an intermediate portion between the inner circumferential portion and the outer circumferential portion, the screw insertion hole being formed in the center of the inner circumferential portion, and at least one disk and at least one spacer are mounted around the outer circumferential surface of the outer circumferential portion.

5. The spindle motor of claim 4, wherein the inner circumferential portion and the outer circumferential portion of the height adjustment member contact a top surface of the rotator, and the intermediate portion of the height adjustment member has a thickness less than the thicknesses of the inner circumferential portion and the outer circumferential portion and is spaced a predetermined distance from the top surface of the rotator.

6. The spindle motor of claim 4, wherein the height adjustment member has a protrusion protruding around the screw insertion hole, and the protrusion contacts the head of the clamping screw to be pressed vertically.

7. The spindle motor of claim 4, wherein the height of the outer circumferential portion of the height adjustment member is equal to the sum of the thicknesses of at least one of the disks and at least one of the spacers.

8. The spindle motor of claim 4, wherein the diameter of an outer circumferential surface of the height adjustment member is equal to the diameter of an outer circumferential surface of the rotator.

9. The spindle motor of claim 1, wherein two disks are mounted around an outer circumference of the rotator, and one disk is mounted around an outer circumferential surface of the height adjustment member.

10. The spindle motor of claim 1, wherein the height adjustment member is made of engineering plastic or metal.

11. The spindle motor of claim 10, wherein the metal is titanium or aluminum.

12. A height adjustment member for a spindle motor having at least a shaft and a rotator rotatably mounted to the shaft, wherein the height adjustment member is supported on the rotator and adjusts the height of the rotator when the number of data storage disks mounted on the spindle motor is increased.

13. The height adjustment member according to claim 12, comprising:
an inner circumferential portion;
an outer circumferential portion; and
a recessed intermediate portion defined between the inner and outer circumferential portions of the height adjustment member;
wherein the height adjustment member supports at least one disk and at least one spacer around an outer circumferential surface of the outer circumferential portion.

14. The height adjustment member according to claim 13, wherein the height adjustment member has a screw insertion hole defined through the center of the inner circumferential portion, the height adjustment member being fixed to the rotator with a clamp and the clamping screw inserted through the screw insertion hole and into an upper end portion of the shaft, such that the height adjustment member is rotatable with the rotator.

15. The height adjustment member according to claim 13, wherein the recessed intermediate portion has a thickness less than the thicknesses of the inner and outer circumferential portions of the height adjustment member.

16. The height adjustment member according to claim 13, wherein the inner and outer circumferential portions of the height adjustment member contact a top surface of the rotator, suspending the recessed intermediate portion over the top surface of the hub.

17. The height adjustment member according to claim 14, wherein the inner circumferential portion of the height adjustment member has a protrusion that surrounds the screw insertion hole, the protrusion contacting a head of the clamping screw.

18. The height adjustment member according to claim 13, wherein the height of the outer circumferential portion of the height adjustment member is approximately equivalent to the sum of the thickness of at least one of the disks and at least one of the spacers.

19. The height adjustment member according to claim 12, wherein the diameter of an outer circumferential surface of the height adjustment member is approximately equal to the diameter of an outer circumferential surface of the rotator.

20. A spindle motor, comprising:
a shaft having an upper end portion;
a stator coupled to an outer circumference of the shaft;
a rotator rotatably mounted on an outer circumference of the shaft and arranged around the stator in a rotatable manner relative to the stator;
a height adjustment member being supported on the rotator and supporting at least one disk and at least one spacer about an outer circumferential surface of the height adjustment member; and
a clamp fixing the height adjustment member to the rotator such that the height adjustment member is rotatable with the rotator.
